(19) United States
(12) Patent Application Publication
(10) Pub. No.: US 2019/0122156 A1
(43) Pub. Date: Apr. 25, 2019

(54) Orchestration Engine Blueprint Milestones

(71) Applicant: International Business Machines Corporation, Armonk, NY (US)

(72) Inventors: Neeraj Asthana, Acton, MA (US); Thomas Chefalas, Somers, NY (US); Alexei Karve, Mohegan Lake, NY (US); Clifford A. Pickover, Yorktown Heights, NY (US); Maja Vukovic, New York, NY (US)

(21) Appl. No.: 15/789,940

(22) Filed: Oct. 20, 2017

(51) Int. Cl. G06Q 10/06; G06F 7/02

(52) U.S. Cl. CPC G06Q 10/06315; G06F 7/026

(57) ABSTRACT

A method and system of assigning computing resources of a cloud by an orchestration engine is provided. A workload request is received via a network. A blueprint is extracted from the workload request. Milestones associated with the blueprint are identified. Business rules associated with the blueprint are determined. A cost of each of the identified milestones is determined. Upon determining that there is interdependence between at least some of the identified milestones, a group of milestones that are interdependent is created. The milestones are ranked based on the determined business rules and determined cost. A deployment plan is executed based on the ranked milestones.

### BACKGROUND

### Technical Field

The present disclosure generally relates to cloud computing architectures and management methodologies, and more particularly, to implementing fulfillment of cloud services order.

### Description of the Related Art

Cloud computing refers to the practice of using a network of remote servers hosted on a public network (e.g., the Internet) to deliver information computing services (i.e., cloud services) instead of providing such services on a local server. The network architecture (e.g., virtualized information processing environment comprising hardware and software) through which these cloud services are provided to service consumers (i.e., a cloud service consumers) is referred to as “the cloud,” which can be a public cloud (e.g., cloud services provided publicly to cloud service consumers), a private cloud (e.g., a private network or data center that supplies cloud services to only a specified group of cloud service consumers within an enterprise), a community cloud (e.g., a set of cloud services provided publicly to a limited set of cloud service consumers, e.g., to agencies with a specific State/Region or set of States/Regions), dedicated/hosted private cloud, a hybrid cloud (any combination of the above), or other emerging cloud service delivery models. Cloud computing attempts to provide seamless and scalable access to computing resources and information technology (IT) services to cloud service consumers.

Cloud services can be broadly divided into four categories: Infrastructure-as-a-Service (IaaS), Platform-as-a-Service (PaaS), Software-as-a-Service (SaaS), and Managed Services. Infrastructure-as-a-Service refers to a virtualized computing infrastructure through which cloud services are provided (e.g., virtual server space, network connections, bandwidth, IP addresses, load balancers, etc.). Platform-as-a-Service in the cloud refers to a set of software and product development tools hosted on the cloud for enabling developers (i.e., a type of cloud service consumer) to build applications and services using the cloud. Software-as-a-Service refers to applications that are hosted on and available on-demand by cloud service consumers via the cloud. Managed Services refers to services such as backup administration, remote system administration, application management, security services, etc., that are enabled by managed service providers for any cloud services.

### SUMMARY

According to various embodiments, a computing device, a non-transitory computer readable storage medium, and a method are provided to assign computing resources of a cloud by an orchestration engine. A workload request is received via a network. A blueprint is extracted from the workload request. Milestones associated with the blueprint are identified. Business rules associated with the blueprint are determined. A cost of each of the identified milestones is determined. Upon determining that there is interdependence between at least some of the identified milestones, a group of milestones that are interdependent is created. The milestones are ranked based on the determined business rules and determined cost. A deployment plan is executed based on the ranked milestones.

In some embodiments, the workload request includes business rules and identification information of a cloud service consumer associated with the workload.

In one embodiment, ranking of the milestones based on the determined business rules includes creating a deployment plan that executes the milestones that do not violate the business plan in parallel.

In one embodiment, upon completion of each milestone, a result of the milestone is reported.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 illustrates an example architecture for orchestrating the computing resources of a cloud.

FIG. 2 illustrates a blueprint that includes milestones, consistent with an exemplary embodiment.

FIG. 3 illustrates an example timeline of a group of interdependent milestones.

FIG. 4 illustrates an example multi-dimensional array of parameters that are considered by the orchestration engine.

FIG. 5 presents an illustrative process for assigning computing resources of a cloud by an orchestration engine.

FIG. 6 depicts a cloud computing environment, consistent with an illustrative embodiment.

FIG. 7 depicts abstraction model layers, consistent with an illustrative embodiment.

FIG. 8 is a functional block diagram illustration of a computer hardware platform that can communicate with various networked components, consistent with an illustrative embodiment.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

The present disclosure relates to systems and methods of assigning computing resources of a cloud by an orchestration engine. As used herein, orchestration relates to aligning a business request, sometimes referred to herein as a workload, with the resources (e.g., applications, data, and infrastructure) of a cloud. Orchestration defines the policies and service levels through automated workflows, provisioning, and change management. Orchestration can scale up or down the resources based on the workload. Orchestration also provides centralized management of the resource pool, including billing for the consumed resources.

Known orchestration engines include, but are not limited to, OpenStack Heat, HashiCorp Terraform, and VMware vRealize Automation, which support hybrid cloud automation. These engines create, configure, and destroy computational resources such as Infrastructure, Virtual Machines, Middleware, etc. Orchestration engines typically process architecture blueprints (sometimes referred to as patterns or templates) to allocate cloud resources.

There are several challenges and limitations in regard to implementing and managing cloud services that arise from the traditional cloud orchestration systems. Examples of these challenges and limitations include, but are not limited to, efficiency in cost, performance, security, reliability, and business impact. Deployment plans of a workload are typically deployed without balancing these concerns.

Accordingly, what is provided herein is a method and system for orchestrating the provisioning of computing resources of a cloud by an orchestration engine that takes into consideration milestones, costs, and business rules of a workload request provided by a cloud service consumer. A workload request is received via a network. A blueprint is extracted from the workload request. Milestones associated with the blueprint are identified. Business rules associated with the blueprint are determined. A cost of each of the identified milestones is determined. Upon determining that there is interdependence between at least some of the identified milestones, a group of milestones that are interdependent is created. The milestones are ranked based on the determined business rules and determined cost. A deployment plan is executed based on the ranked milestones. Reference now is made in detail to the examples illustrated in the accompanying drawings and discussed below.

### Example Architecture

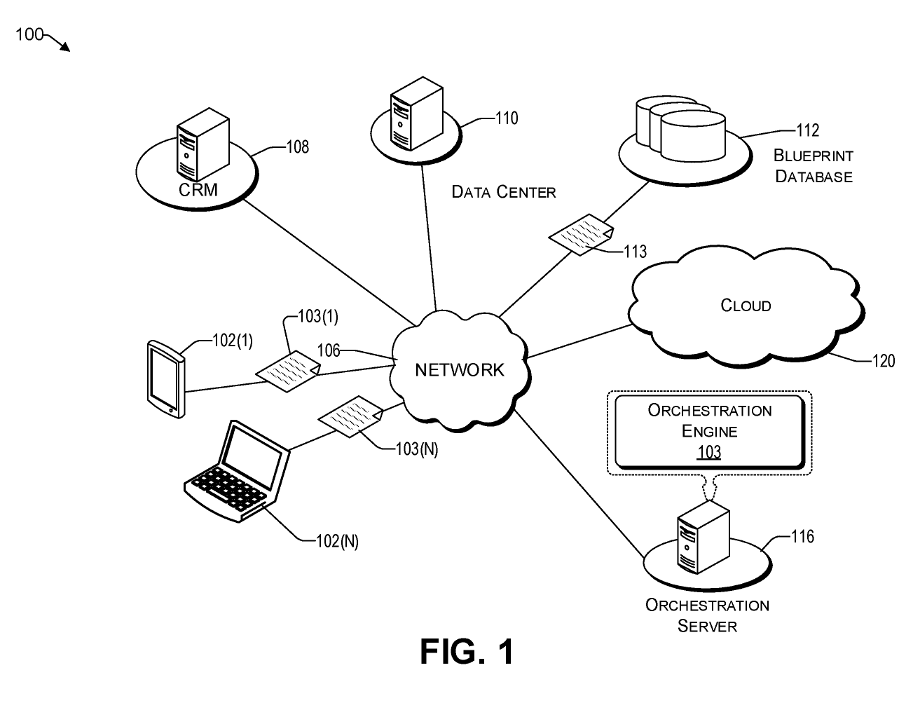

FIG. 1 illustrates an example architecture 100 for orchestrating the computing resources of a cloud 120. Architecture 100 includes a network 106 that allows various computing devices 102(1) to 102(N) to communicate with each other and various resources that are connected to the network 106, such as a customer relations manager (CRM) server 108, one or more data centers 110, a blueprint database 112, an orchestration server 116, and a cloud 120.

The network 106 may be, without limitation, a local area network (“LAN”), a virtual private network (“VPN”), a cellular network, the Internet, or a combination thereof. For example, the network 106 may include a mobile network that is communicatively coupled to a private network, sometimes referred to as an intranet, that provides various ancillary services, such as communication with various application stores, libraries, the Internet, and the cloud 120.

For purposes of later discussion, several computing devices appear in the drawing, to represent some examples of the devices that may receive various resources via the network 106. Today, computing devices typically take the form of portable handsets, smart-phones, tablet computers, laptops, desktops, personal digital assistants (PDAs), and smart watches, although they may be implemented in other form factors, including consumer, and business electronic devices.

A computing device (e.g., 102(1)) provides a workload request 103(1), sometimes referred to herein as a business request, to the orchestration engine 103, which is a software program running on the orchestration server 116. Each workload includes a blueprint, which is a declarative representation of the workload that is both human and machine readable. It describes the relevant resources and the properties thereof. Blueprints provide an architectural overview of a platform that is later virtualized on the cloud by way of the orchestration engine 103. For example, a blueprint allows the specification of desired resources, without the requirement of detailed programming commands that describe the creation of those resources.

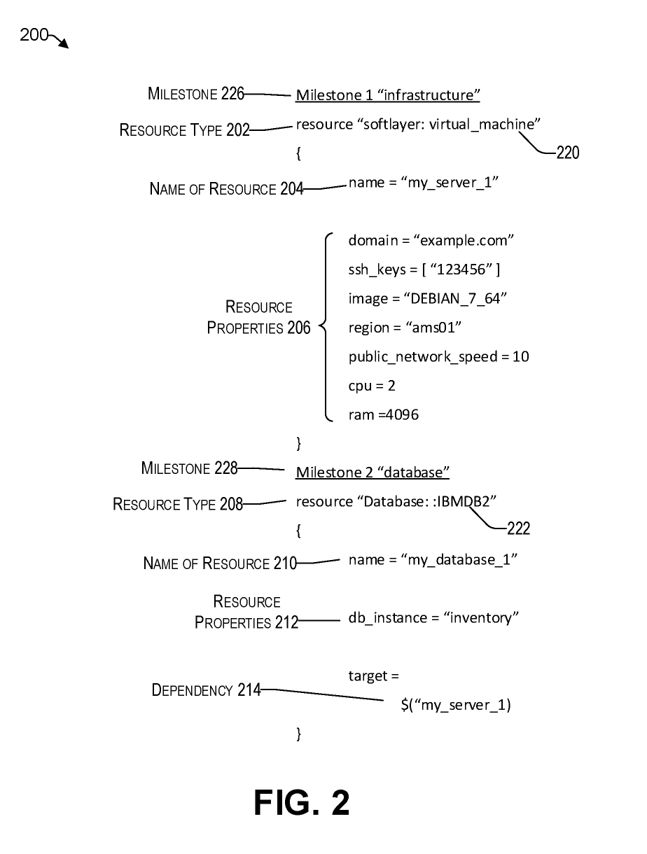

In this regard, FIG. 2 illustrates a blueprint 200, consistent with an exemplary embodiment. By way of example only, and not by way of limitation, the blueprint 200 is with respect to a virtual machine 220 and a Relational Database Management System (RDBMS) 222. The blueprint 200 provides a resource type 202, a name of the resource 204, and resource properties 206 for a virtual machine. It also defines the resource type 208, name of resource 210, and resource properties 212 of the RDBMS.

Accordingly, a blueprint provides the attributes of the requested resources, the manner in which it is provisioned, and its policy and management settings. A blueprint can be a reusable asset for repeated use. For example, it can be reused across customers, sometimes referred to herein as cloud service consumers, and can be repeatedly used by the orchestration engine 103.

Thus, a blueprint defines one or more resources to be created by way of the orchestration engine 103. A blueprint can also include dependencies. For example, a blueprint 200 can define relationships and dependencies between the resources (e.g., 204 and 210). In the example of FIG. 2, a DB2 instance has an association with a SoftLayer virtual machine 220, thereby creating a dependency for the DB2 service 222.

For example, the dependencies between resources are included such that they are created in the correct order by the orchestration engine. Each resource is uniquely named within the blueprint 200. In various embodiments, each named resource (e.g., 204 and 210) in the blueprint 200 has its property values explicitly set to a value or implicitly set via a reference to a property from a different named resource in the blueprint or implicitly set via a reference to an input parameter to the blueprint 200, and/or be nested, which enables the decomposition of deployment into a set of targeted, purpose-specific blueprints.

In various embodiments, a blueprint may have milestones (e.g., 226 and 228) provided as part of the workload, or the milestones may be determined by the orchestration engine 103 based on the resources within a blueprint. In one embodiment, milestones can be determined for a blueprint based on comparisons provided via the blueprint database 112, discussed in more detail later. As used herein, a milestone is a grouping of one or more resources that defines a specific achievement in the provisioning of the grouped resources.

Referring back to FIG. 1, the orchestration engine 103 is configured to receive one or more workloads 103(1) to 103(N). For each workload, the orchestration engine 103 extracts the blueprint therefrom. A blueprint can be received as a readable text file often as a YAML, JavaScript Object Notation (JSON), or HashiCorp Configuration Language (HCL). For each blueprint, the orchestration engine 103 determines the corresponding milestones. As mentioned above, in various embodiments, the milestones may be already included in the blueprint, or the orchestration engine 103 can determine the milestones based on the various resources identified in the blueprint.

The orchestration engine 116 is also configured to determine the business rules with respect to the received workload 103(1). The business rules may include, without limitation, the budget, preferences, priorities, risk tolerance, time constraints, geographical constraints, etc. In various embodiments, the business rules may be provided as part of the workload 103(1) or retrieved from the CRM server 108. For example, the CRM may store a service level agreement (SLA) that includes the business rules.

Accordingly, in one embodiment, there is a CRM server 108 that is coupled for communication via the network 106. In the example of FIG. 1, the CRM server 106 offers its account holders (e.g., cloud service consumers) on-line access to a variety of functions related to the account holders' account, such as on-line payment information, subscription changes, password control, etc., including business rules with respect to their work-loads.

The orchestration engine 103 is also configured to determine the interdependence between milestones. As discussed above, one or more milestones may depend upon the completion of another milestone. In one embodiment, the interdependent milestones are grouped together as an interdependent milestone group comprising individual milestones. The orchestration engine 103 can estimate the time it takes to fulfill each individual milestone in the group of interdependent milestones. In one embodiment, each individual milestone is triggered at a time relative to the other individual milestones in the interdependent milestone group such that milestones that are in the critical path of another milestone in the group, complete at a substantially similar time. The substantially similar time may be before an actual due date.

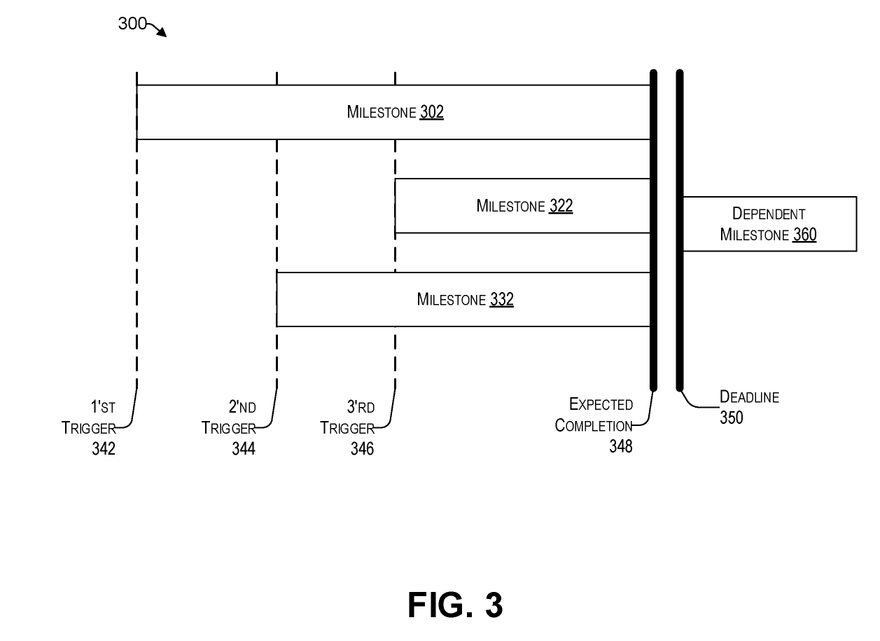

In this regard, FIG. 3 illustrates an example timeline 300 of a group of interdependent milestones. Upon determining the deadline 350, the orchestration engine 103 creates an expected completion time 348 that is at or before the deadline 350. The first milestone 302 is triggered at time 342, the third milestone 332 is triggered at time 344, and the second milestone 322 is triggered at time 346. In this way, the deployment plan for blueprint can have an execution order of milestones 302, 322, and 332 such that the individual milestones 302, 322, and 332 in the group of interdependent milestones can complete at the expected completion time 348 to accommodate milestone 360 that depends on the results of milestones 302, 322, and 332.

Referring back to FIG. 1, the time estimate for the completion of each individual milestone, sometimes referred to herein as prediction, may be determined in various ways. For example, predictions may be computed based on historical data of other substantially similar milestones, social networking data from cloud service consumers, etc., represented by the data center 110. A prediction is an unknown quantity that is to be assessed, estimated, or forecast for an entity. Predictions are made by running a milestone through predictive models, which can be considered as formulas that map input variables to an estimation of the output. In this regard, the blueprint database 112 may include various models of other substantially similar blueprints 113 that are based on substantially similar business rules. Accordingly, the orchestration engine 103 may run various algorithms, such as noise tolerant time varying graphs and other predictive analytics, based on the data provided by the blueprint database 112, which is related to substantially similar milestones.

In one embodiment, the orchestration engine 103 ranks the milestones (and any groups of interdependent milestones) based on the identified business rules. For example, the business rules may indicate that the cloud service consumer responsible for the workload 103(1) may have specific time and/or budget constraints. If the business rules impose constraints (e.g., budgetary, risk, reliability, etc.), then the orchestration engine 103 (e.g., instead of running various independent milestones in parallel) can rank and execute the milestones based on the business rules. For example, if there are budgetary constraints and certain milestones are identified to be important for a business enterprise of the cloud service consumer, then those certain milestones are deemed to have higher priority, such that they are completed without exceeding the budgetary constraints. Also, in low resource cloud 120 environments, some important milestones may execute while other less important milestones are delayed for the resource availability, to begin execution. In some embodiments, the cloud service consumer is billed on a pay-per-milestone basis, by requesting a payment when a milestone is achieved, thereby distributing a cost of a blueprint, overtime.

Thus, in various scenarios, depending on the interdependence of milestones, the milestones deployment plan of the orchestration engine may execute one or more milestones independently, and allow for parallelization of milestones. Significantly, unlike other blueprints used for orchestration, in the blueprints used by the orchestration engine 103, if one milestone fails, other milestones can still execute and complete without crashing the entire blueprint.

The orchestration engine 103 is also configured to provide notifications to one or more authorized recipients, such as an administrator of the cloud service consumer in connection with the workload 103(1). In one embodiment, the recipients of the notification are identified in the CRM server 108 based on the account information provided in the workload 103(1). The notifications may be with respect to the successful completion of individual milestones or groups of milestones, and/or failure thereof. Thus, partial achievement of provisioning based on type/number of resources specified for a milestone can trigger a notification, thereby facilitating a cloud service consumer to initiate appropriate action. Stated differently, cloud service consumers may be informed when important milestones are achieved in blueprint execution and may perform separate actions while other milestones continue to execute (e.g. by adding software, adding users, hardening OS, informing customers, etc.).

The notification may be sent in various ways, such as common short code (CSC) using a short message service (SMS), multimedia message service (MIMS), e-mail, telephone, social media, etc. In various embodiments, the notification can be provided on a user interface of the computing device (e.g., 102(1)) in the form of a message on the screen, an audible tone, a haptic signal, or any combination thereof.

In one embodiment, the architecture 100 can enable a developer (e.g., a cloud service consumer) to define a logical, multi-tier application blueprint that may be used to create and manage (e.g., redeploy, upgrade, backup, patch) multiple applications in a cloud 120 infrastructure. In one example, specific milestones for public cloud deployments may host the front-end tier using Cloud Foundry, next the middle-tier may be deployed on Amazon Elastic Compute Cloud (EC2), and the on-premises bare-metal machines may be used as the back-end. Each of these can be independent milestone goals. Failure of one milestone does not affect other milestones in the blueprint.

In the blueprint of a workload 103(1), the developer may optionally model an overall application architecture, or topology, that includes individual and clustered nodes (e.g., virtual machines (VMs) or containers or pods), logical templates, cloud providers, deployment environments, software services, application-specific code, properties, and dependencies between top-tier and second-tier components. The workload 103(1) can be deployed by inferring milestones according to the application blueprint, which means any salient VMs are provisioned as one milestone from the cloud infrastructure, and application components in the next milestone, and software services are installed in the last milestone in the deployment plan. Such approach allows the cloud service consumer to be informed of the progress, as each milestone is completed, thereby providing improved feedback. Resources within a blueprint may be shared between milestones. The shared resource plays a part in each of the milestones it is included in. The more milestones a resource belongs to, the more constrained it gets and therefore its priority may increase.

While the discussion above describes the provisioning of a workload 103(1) on the resources of the cloud via an orchestration engine 103, it should be noted that a similar approach can be performed in the de-provisioning of the workload 103(1). Stated differently, the de-provisioning of the workload 103(1) can be performed in the reverse order of the provisioning. There may be separate milestones during de-provisioning. For example—Cleanup of an instance created from a Blueprint that has VMs registered with NewRelic Monitoring: The Initial milestone will get rid of the VM resources. However, NewRelic may not allow to deregister the VM immediately. This may involve another long running or event based action that proceeds in another milestone. There is a timeout period during which, if no requests are received from the Virtual Machine to NewRelic, then NewRelic moves the VM to the “No data reporting state”. It is in this state that the VM can be deregistered from NewRelic.

While the CRM server 108, data center 110, blueprint database 112, and orchestration server 116 are illustrated by way of example to be on different platforms, it will be understood that in various embodiments, these platforms may be combined in various combinations. In other embodiments, these computing platforms may be implemented by virtual computing devices in the form of virtual machines or software containers that are hosted in the cloud 120, thereby providing an elastic architecture for processing and storage.

### Example Multi-Dimensional Approach

As mentioned previously, in one embodiment, the orchestration engine takes the business rules of a workflow into consideration. The orchestration engine may weigh different factors of the business rules to determine the appropriate deployment plan of the identified milestones.

Thus, the orchestration engine 103 may use a multidimensional approach that takes into consideration different relevant business dimensions, such as risk, reliability, cost, security, etc. Even within a business rule, such as risk, there may be several considerations. Indeed, estimated risk need not be a scalar value but may be a multidimensional vector that may take into consideration different dimensions and kinds of risk.

For example, some cloud service consumers may focus on “performance,” whereas others may consider “reliability” the most important risk to take into consideration, with respect to a hierarchy of risks. For example, a high-dimensional risk array may be generated by the orchestration engine 103, based on the specific business rules provided by the cloud service consumer, to provide an appropriate deployment plan.

Other cloud computing risks may include risks that are associated with one or more of: unauthorized access to customer and business data, security risks at the vendor; compliance, regulatory, and legal risks; risks related to lack of control, availability risks, a stakeholder's business and clients being at risk; risk of loss or theft of intellectual property; risk of malware infections that may make the cloud service consumer vulnerable to a security attack; risk of contractual breaches, increased customer churn, revenue loss, etc. Some of these risk factors may be easier than others to quantify and track, and each may have a “confidence value” or “importance value” associated with the factor.

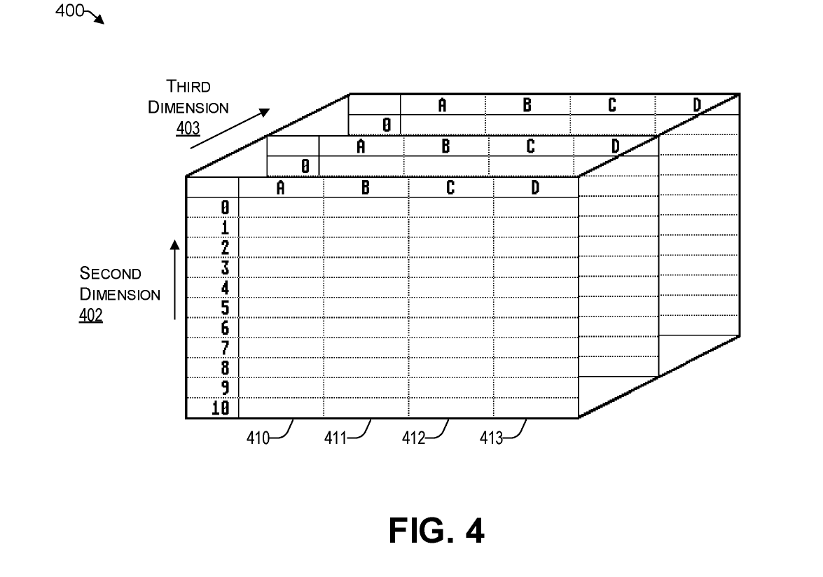

In this regard, FIG. 4 illustrates an example multi-dimensional array 400 of parameters that are considered by the orchestration engine. Each blueprint may have a separate multi-dimensional array 400, each cell including the ordering of the milestones that satisfy the risk factors of the axes. While three dimensions are illustrated by way of example in FIG. 4, it will be understood that additional or fewer dimensions are supported as well by the teachings herein.

For example, the first dimension 401 may relate to cost, the second dimension 402 may relate to risk, and the third dimension 403 may relate to reliability. Each different column 410 to 413 for cost, may relate to a different type of cost, such as Free, Low, Medium, High. Similarly, there may be different types of risks factors, represented by rows 0 to 9 representing Lowest Risk, to High Risk and reliability of 99.9% and 99.999%. Few of the cells in the multi-dimensional array may not have any orderings of the milestones that satisfy the importance value and will be empty. For example, we may not have an ordering that satisfies “99.999%” reliability with “Free” cost. For such case, we use the weighting to find a non-empty cell. In one embodiment, dimensions that are deemed by the cloud service consumer to be more important are more heavily weighted. The orchestration engine determines the weighting factor for each parameter based on the business rules for a workload. The orchestration engine analyzes the different possible permutations and identifies the most appropriate deployment plan for the workload in view of the business rules associated therewith.

In some embodiments, artificial intelligence AI is used to automatically generate a deployment plan in view of various parameters identified in the business rules. For example, AI planning tools, such as TLPlan, may be used by the orchestration engine to automate generation of a deployment plan to find an appropriate balance between the identified parameters of the business rules. TLPlan is a planning system that can use the milestones in a blueprint and the parameters of the business rules to generate plans that meet the desired goals identified in the blueprint and the business rules. Furthermore, milestones may be bundled or hierarchically organized to optimize the deployment plan. For example, in various scenarios, milestones can be executed independently, in parallel, a series of steps, or any combination thereof, based on the information provided in the milestone (e.g., dependencies, resources available, etc.).

In one embodiment, the orchestration engine uses machine learning based on a training set provided by the blueprint database 112 of FIG. 1 to determine an appropriate deployment plan for the identified milestones, in view of the business rules for the particular workload. Machine learning is a subfield of computer science that evolved from the study of pattern recognition and computational learning theory inartificial intelligence. Machine learning is used herein to construct algorithms that can learn from and make predictions based on the data stored in the blueprint database. Such algorithms operate by building a model from stored prior inputs or baselines therefrom in order to make data-driven predictions or decisions (OR to provide threshold conditions to indicate an appropriate order of the milestones and/or interdependent milestone groups), rather than following strictly static criteria. Based on the machine learning, patterns and trends are identified, which are used to develop a deployment plan that includes an order of milestones (and/or interdependent milestone groups) within a blueprint.

In various embodiments, the machine learning discussed herein may be supervised or unsupervised. In supervised learning, the orchestration engine may be presented with example data from the blueprint database as being acceptable. Put differently, the blueprint database acts as a teacher for the orchestration engine. In unsupervised learning, the blueprint database does not provide any labels as what is acceptable, rather, it simply provides historic data to the orchestration engine that can be used together with the recently identified milestones and business rules to find its own structure among the data.

In various embodiments, the machine learning may make use of techniques such as supervised learning, unsupervised learning, semi-supervised learning, naïve Bayes, Bayesian networks, decision trees, neural networks, fuzzy logic models, and/or probabilistic classification models.

### Example Process

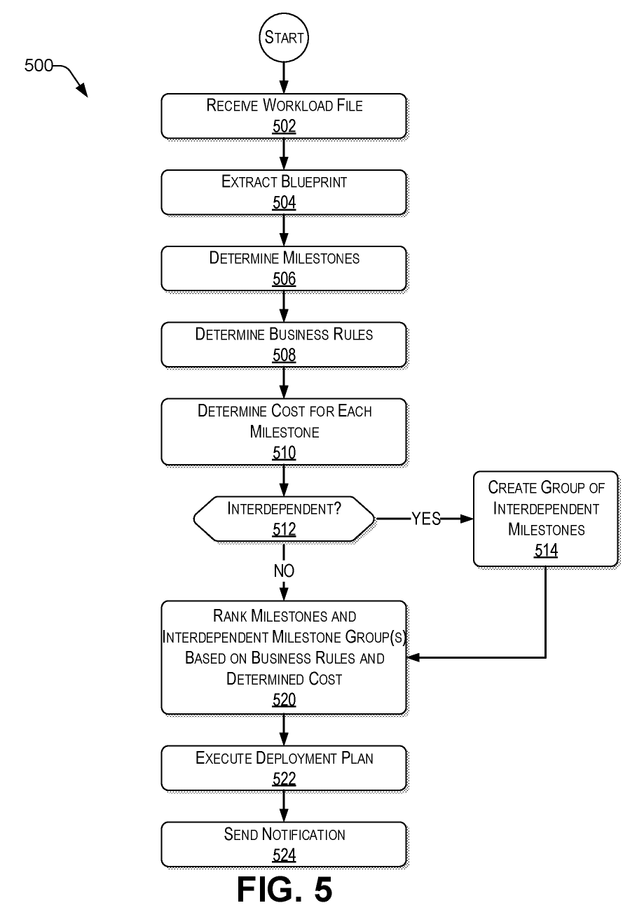

With the foregoing overview of the example architecture 100, an example timeline 300 of a group of interdependent milestones, and an example multi-dimensional array 400 of parameters that are considered by the orchestration engine, it may be helpful now to consider a high-level discussion of an example process. To that end, FIG. 5 presents an illustrative process 500 for assigning computing resources of a cloud by an orchestration engine.

Processes 500 is illustrated as a collection of blocks in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. The order in which the operations are described is not intended to be construed as a limitation, and any number of the described blocks can be combined in any order and/or performed in parallel to implement the process. For discussion purposes, the process 500 is described with reference to the architecture 100 of FIG. 1.

At block 502, the orchestration engine 103 running on the orchestration server 116 receives a workload request (e.g., 103(1)) via the network 106. The workload request includes a blueprint. In some embodiments, the workload request (e.g., 103(1)) includes the business rules and/or identification information of the cloud service consumer associated with the workload. In other embodiments, the business rules are received from the CRM 108.

At block 504, the orchestration engine 103 determines the blueprint from the received workload request (e.g., 103(1)). At block 506, the orchestration engine 103 determines the milestones from the blueprint. In various embodiments, the blueprint may have pre-identified milestones, or the orchestration engine determines the milestones based on resources identified within the blueprint. In some embodiments, the blueprint database 112 has reference milestones that may be used as a comparison for the orchestration engine 103 to identify milestones.

At block 508, the orchestration engine 103 determines the business rules. In various embodiments, the business rules can be extracted from the workload and/or received from the CRM 108.

At block 510, the cost for each milestone is determined. As used herein, cost can relate to time to complete, budgetary cost, risk, etc.

At block 512 the orchestration engine 103 determines whether any of the identified milestones is interdependent. If so, (i.e., “YES” at decision block 512), the process continues with block 514, where a group of milestones that are interdependent are created. In one embodiment, each milestone of the group of milestones that are interdependent is triggered at a time relative to the other milestones in the group, such that all milestones in the group that are in a critical path complete at a substantially similar time before a trigger of their dependent milestone, as explained previously in the context of FIG. 3. The process then continues with block 520, discussed below

Returning to block 512, upon the orchestration engine 103 determining that there is no interdependence between the milestones (i.e., “NO” at decision block 512), the process continues with block 520, where the milestones (and possible interdependent milestone groups) are ranked based on the business rules and the determined cost. For example, if the business rules allow (e.g., there are no budgetary or risk concerns), then the milestones (and possible interdependent milestone groups) can be run in parallel, thereby saving substantial time in completing the workload.

At block 524, upon completion of each milestone a notification is sent to an appropriate recipient. The notifications may be with respect to the successful completion of individual milestones or groups of interdependent milestones, and/or failure thereof.

### Example Cloud Platform

As discussed above, functions relating to provisioning a workload by the orchestration server may include a cloud. It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least fourdeployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

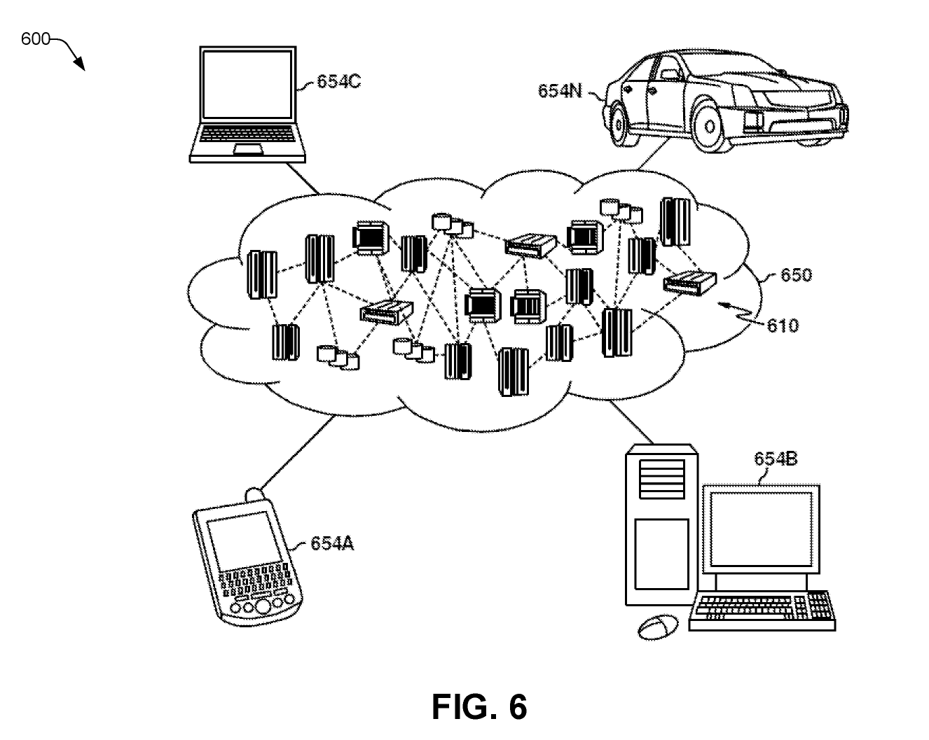

A cloud computing environment is service oriented with a focus on statelessness, low coupling, modularity, and semantic interoperability. At the heart of cloud computing is an infrastructure that includes a network of interconnected nodes. Referring now to FIG. 6, an illustrative cloud computing environment 600 is depicted. As shown, cloud computing environment 600 includes one or more cloud computing nodes 610 with which local computing devices used by cloud consumers, such as, for example, personal digital assistant (PDA) or cellular telephone 654A, desktop computer 654B, laptop computer 654C, and/or automobile computer system 654N may communicate. Nodes 610 may communicate with one another. They may be grouped (not shown) physically or virtually, in one or more networks, such as Private, Community, Public, or Hybrid clouds as described hereinabove, or a combination thereof. This allows cloud computing environment 650 to offer infrastructure, platforms and/or software as services for which a cloud consumer does not need to maintain resources on a local computing device. It is understood that the types of computing devices 654A-N shown in FIG. 1 are intended to be illustrative only and that computing nodes 610 and cloud computing environment 650 can communicate with any type of computerized device over any type of network and/or network addressable connection (e.g., using a web browser).

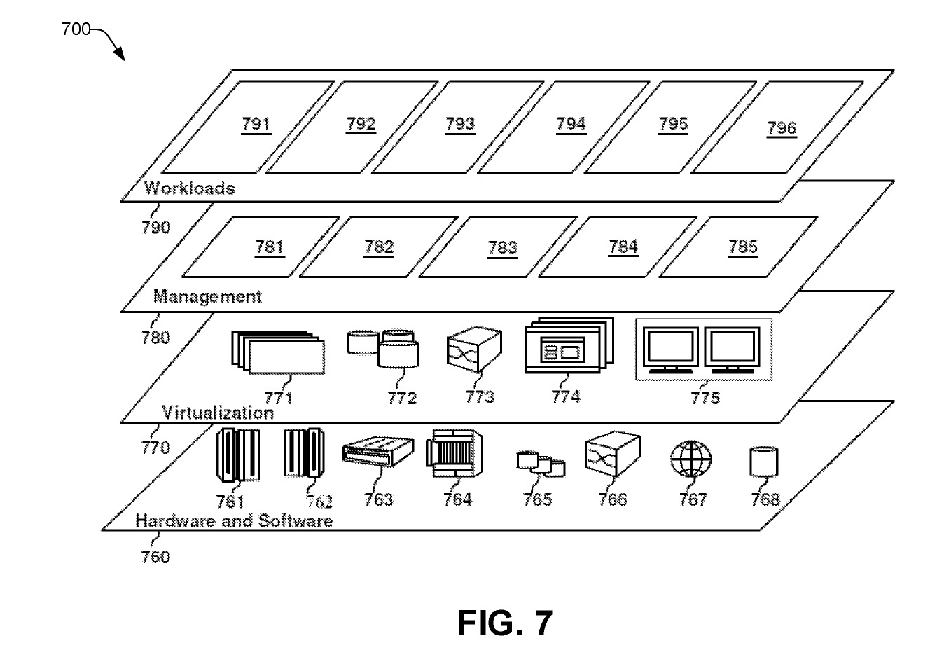

Referring now to FIG. 7, a set of functional abstraction layers provided by cloud computing environment 650 (FIG. 6) is shown. It should be understood in advance that the components, layers, and functions shown in FIG. 7 are intended to be illustrative only and embodiments of the disclosure are not limited thereto. As depicted, the following layers and corresponding functions are provided:

Hardware and software layer 760 includes hardware and software components. Examples of hardware components include: mainframes 761; RISC (Reduced Instruction Set Computer) architecture based servers 762; servers 763; blade servers 764; storage devices 765; and networks and networking components 766. In some embodiments, software components include network application server software 767 and database software 768.

Virtualization layer 770 provides an abstraction layer from which the following examples of virtual entities may be provided: virtual servers 771; virtual storage 772; virtual networks 773, including virtual private networks; virtual applications and operating systems 774; and virtual clients 775.

In one example, management layer 780 may provide the functions described below. Resource provisioning 781 provides dynamic procurement of computing resources and other resources that are utilized to perform tasks within the cloud computing environment. Metering and Pricing 782 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 783 provides access to the cloud computing environment for consumers and system administrators. Service level management 784 provides cloud computing resource allocation and management such that required service levels are met. Service Level Agreement (SLA) planning and fulfillment 785 provide pre-arrangement for, and procurement of, cloud computing resources for which a future requirement is anticipated in accordance with an SLA.

Workloads layer 790 provides examples of functionality for which the cloud computing environment may be utilized. Examples of workloads and functions which may be provided from this layer include: mapping and navigation 791; software development and lifecycle management 792; virtual classroom education delivery 793; data analytics processing 794; transaction processing 795; and other functions 796.

### Example Computer Platform

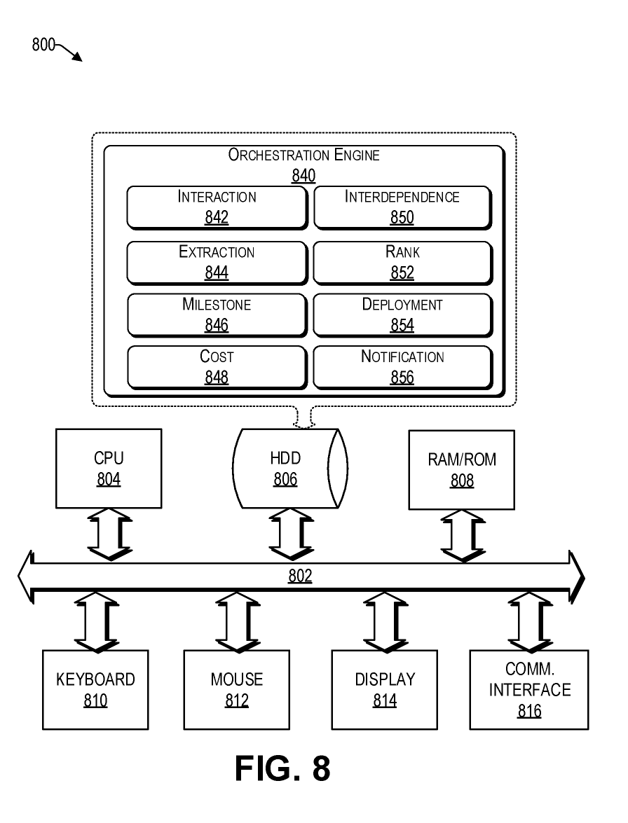

As discussed above, functions relating to assigning computing resources of a cloud by an orchestration engine can be performed with the use of one or more computing devices connected for data communication via wireless or wired communication, as shown in FIG. 1 and in accordance with the process 500 of FIG. 5. FIG. 8 is a functional block diagram illustration of a computer hardware platform that can communicate with various networked components, such as other computing devices 102(1) to 102(N), CRM server 108, data center 110, blueprint database 112, the cloud 120, and other devices coupled to the network 106. In particular, FIG. 8 illustrates a network or host computer platform 800, as may be used to implement a server, such as the orchestration server 116 of FIG. 1.

The computer platform 800 may include a central processing unit (CPU) 804, a hard disk drive (HDD) 806, random access memory (RAM) and/or read only memory (ROM) 808, a keyboard 810, a mouse 812, a display 814, and a communication interface 816, which are connected to a system bus 802.

In one embodiment, the HDD 806, has capabilities that include storing a program that can execute various processes, such as the orchestration engine 840, in a manner described herein. The orchestration engine 840 may have various modules configured to perform different functions.

For example, there may be an interaction module 842 that is operative to receive workload documents from computing devices, receive information from data centers and the blueprint database, as discussed herein.

In one embodiment, there is an extraction module 844 operative to extract the blueprint from the workload document.

In one embodiment, there is a milestone module 846 operative to identify and/or determine milestones from the blueprint. In some embodiments, the milestone module 846 interacts with the blueprint database to receive comparisons therefrom.

In one embodiment, there is a cost module 848 operative to estimate the time it may take to complete a milestone, budgetary cost, risk, etc.

In one embodiment, there is an interdependence module 850 operative to determine whether there is interdependence between modules. If so, the interdependence module 850 can create a group of interdependent milestones that can be ranked as a single element by the ranking module 852. Accordingly, in one embodiment, there is a ranking module 852 operative to rank the milestones (and possible interdependent milestone groups) based on the business rules and the determined cost.

In one embodiment, there is deployment module 854 operative to create a deployment plan based on the ranking of the modules (and possible interdependent milestone groups).

In one embodiment, there is a notification module 856 operative to report a status of each milestone upon completion of the milestone, to one or more appropriate recipients.

In one embodiment, a program, such as Apache™, can be stored for operating the system as a Web server. In one embodiment, the HDD 806 can store an executing application that includes one or more library software modules, such as those for the Java™ Runtime Environment program for realizing a JVM (Java™ virtual machine).

### Conclusion

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computing device comprising:
a processor;
a network interface coupled to the processor to enable communication over a network;
a storage device coupled to the processor;
an orchestration engine software stored in the storage device, wherein an execution of the software by the processor configures the computing device to perform acts comprising:
receiving a workload request via the network;
extracting a blueprint from the workload request;
identifying milestones associated with the blueprint;
determining business rules associated with the blueprint;
determining a cost of each of the identified milestones;
upon determining that there is interdependence between at least some of the identified milestones, creating a group of milestones based on these interdependent milestones;
ranking milestones based on the determined business rules and determined cost; and
executing a deployment plan based on the ranked milestones.

2. The computing device of claim 1, wherein the workload request includes a blueprint.

3. The computing device of claim 2, wherein the workload request includes business rules and identification information of a cloud service consumer associated with the workload.

4. The computing device of claim 1, wherein the business rules are at least one of:
received from a customer relations monitor (CRM) server; and
extracted from the received workload request.

5. The computing device of claim 1, wherein identifying the milestones associated with the blueprint comprises:
identifying one or more resources requested in the blueprint; and
determining the milestones based on the one or more identified resources.

6. The computing device of claim 1, wherein the milestones are defined in the extracted blueprint.

7. The computing device of claim 1, wherein identifying the milestones associated with the blueprint comprises:
identifying one or more resources requested in the blueprint; and
comparing the one or more resources to reference milestones of a database.

8. The computing device of claim 1, wherein a cost of a milestone relates to at least one of:
a financial cost of the milestone;
an estimated time to complete the milestone; and
an estimated risk of the milestone.

9. The computing device of claim 1, wherein execution of the orchestration engine by the processor further configures the computing device to perform acts comprising: upon creating a group of milestones that are interdependent, orchestrating a deployment plan such that each milestone of the group of milestones that are interdependent is triggered at a time relative to the other milestones in the group such that all milestones in the group that are in a critical path complete at a substantially similar time before a trigger of their dependent milestone.

10. The computing device of claim 1, wherein ranking the milestones based on the determined business rules comprises: creating a deployment plan that executes the milestones that do not violate the business plan, in parallel.

11. The computing device of claim 1, wherein execution of the orchestration engine by the processor further configures the computing device to perform an act comprising: upon completion of each milestone, reporting a result of the milestone.

12. The computing device of claim 1, wherein execution of the orchestration engine by the processor further configures the computing device to perform an act comprising: upon determining that a milestone of the identified milestones fails upon execution, allowing other milestones to execute without crashing the blueprint reporting a result of the milestone.

13. A non-transitory computer readable storage medium tangibly embodying a computer readable program code having computer readable instructions that, when executed, causes a computer device to carry out a method of assigning computing resources of a cloud by an orchestration engine, the method comprising:
receiving a workload request;
extracting a blueprint from the workload request;
identifying milestones associated with the blueprint;
determining business rules associated with the blueprint;
determining a cost of each of the identified milestones;
upon determining that there is interdependence between at least some of the identified milestones, creating a group of milestones based on these interdependent milestones;
ranking milestones based on the determined business rules and determined cost; and
executing a deployment plan based on the ranked milestones.

14. The non-transitory computer readable storage medium of claim 13, wherein the workload request includes a blueprint.

15. The non-transitory computer readable storage medium of claim 14, wherein the workload request includes business rules and identification information of a cloud service consumer associated with the workload.

16. The non-transitory computer readable storage medium of claim 13, wherein the business rules are at least one of:
received from a customer relations monitor (CRM) server; and
extracted from the received workload request.

17. The non-transitory computer readable storage medium of claim 13, wherein identifying the milestones associated with the blueprint comprises:
identifying one or more resources requested in the blueprint; and
determining the milestones based on the one or more identified resources.

18. The non-transitory computer readable storage medium of claim 13, wherein the milestones are defined in the extracted blueprint.

19. The non-transitory computer readable storage medium of claim 13, wherein identifying the milestones associated with the blueprint comprises:
identifying one or more resources requested in the blueprint; and
comparing the one or more resources to reference milestones of a database.

20. The non-transitory computer readable storage medium of claim 13, wherein ranking the milestones based on the determined business rules comprises: creating a deployment plan that executes the milestones that do not violate the business plan in parallel.
